(19) United States
(12) Patent Application Publication
(10) Pub. No.: US 2026/0241318 A1
(43) Pub. Date: Aug. 20, 2026

(54) Conversion Assembly for Converting an Outside-to-inside Coalescing Filter System to an Inside-to-outside Coalescing Filter System for Air and Oil Separators and Method of Use

(71) Applicant: Thomas Dailey, Lafayette, LA (US)

(72) Inventor: Thomas Dailey, Lafayette, LA (US)

(21) Appl. No.: 19/057,763

(22) Filed: Feb. 19, 2025

(51) Int. Cl. B01D 46/00

(52) U.S. Cl. CPC B01D 46/0031; B01D 46/0001; B01D 46/0043; B01D 2265/06

(57) ABSTRACT

A gas and oil separator filter assembly for a separator tank. The filter assembly is comprised of a tubular outer shell having gas and oil mixture inlets, a tubular inner shell positioned within and above the outer shell creating an annular flow space, the inner shell having a lower end with a central opening, and a tubular coalescing filter having an inside and an outside positioned within the inner shell above said lower end central opening whereby a flow of a gas and oil mixture is directed through the gas and oil mixture inlets of the tubular outer shell into the annular flow space and into the central opening of the inner shell into a coalescing filter. The gas and oil mixture is then filtered from the inside of the coalescing filter to the outside of the coalescing filter.

### FIELD OF INVENTION

This invention relates to the field of oil and gas separators, more particularly, to an assembly for a coalescing filter assembly for gas and oil separators that inverts the filter flow path from an outside-to-inside flow path to an inside-to-outside flow path when separating a fluid emulsion of oil and gases into separate components.

### BACKGROUND OF INVENTION

Coalescing filters are devices used to a separate fluid mixtures or emulsions into the emulsions individual components utilizing the principle of coalescence. Coalescence is a process whereby fluid individual molecules of oil and gases, including air, agglomerate or group together.

Coalescing filters typically consist of several filter screens comprised of fine filter material or media such as borosilicate glass microfiber and/or rayon/phenolic layers. A fluid stream, such as a fluid stream comprised of a mixture of oil and gas, which may include oils, air, or gases including hydrocarbon gases, is circulated through the coalescing filter screens to screen out the various components of the fluid stream by trapping and separating the components into different sections. When separated, the individual components of the fluid stream can be recovered, and any contaminants can be drained away for further purification or disposal. The use of coalescing filters is an essential process in many industrial settings in order to improve the efficiency of production processes, reduce costs, and improve product quality.

Coalescing filters are essential components of air/oil separators such as those manufactured by Lagrange Products, Inc. of Fremont, Indiana or those used in the gas/oil separator tanks of the rotary screw air compressors manufactured under the name FS-Curtis® by Curtis-Toledo, Inc., 1905 Kienlen Ave, St. Louis, MO 63113. In such rotary screw air compressors, low pressure gas, such air, is introduced into a compression chamber having plurality of vaned rotors used to compress the low pressure air. Oil is introduced into the pressure chamber to control the temperature of the compressed gas, serve as a lubricant, and to seal leakage paths. The compressed gas and oil mixture is then delivered to a separator tank for separation of the gas and the oil mixture. Typically, the separator tank will have a coalescing filter having a flow path that directs the gas and oil mixture from the outside of the coalescing filter to the inside of the coalescing filter. This filter coalesces the oil molecules in the oil molecules in the gas and oil mixture so that the oil will fall to the bottom of the separation tank where it can be reused. The compressed gas is then cooled, processed, and delivered to the system where it can be utilized.

An outside-to-inside flow path to the coalescing filter can result in filtering inefficiencies due to stage separation of the oil and air mixture, inundation of the coalescing filter with oil, oil eruption due to direct contact with the oil and filter, collapse of the filter media, or the proximity of the separated oil to the coalescing filter. The aforementioned inefficiencies may result in diminished filtration, increased filter replacement, equipment wear and tear, and increased cost of gas compression operations. Consequently, a need exists to modify the coalescing filter assembly of a separator tank of rotary screw gas and/or air compressors to eliminate or minimize the aforementioned inefficiencies.

### SUMMARY OF THE INVENTION

The present invention is intended to provide a replacement coalescing filter assembly for air and oil separation tank. The filter assembly of present invention provides a flow path for a fluid mixture of compressed air and oil or a fluid mixture of other compressed gas or gasses and oil (all referred hereinafter referred to as an “gas/oil fluid mixture”) to a coalescing filter in the air and oil separation tank that inverts or reverses the fluid flow path from an outside-to-inside the filter flow path to an inside-to-outside the filter flow path. It is thought that such an inverted inside-to-outside flow path will reduce or eliminate the aforementioned problems and inefficiencies.

It is also thought that the proposed filter assembly will be used to adapt a gas and oil separator tank having a gas/oil fluid mixture inlet, an upper air outlet, a lower oil outlet, and an internal baffle that creates an outside-to-inside gas/oil fluid flow path to a coalescing filter. The replacement filter assembly of the present invention may be placed in such a gas and oil separation tank during its initial construction, however it is thought that the filter assembly of the present invention will primarily be utilized as a replacement filter for existing gas/oil separator tanks.

The filter assembly of the present invention is comprised of a vertically extending tubular outer shell having an open upper or top end, an outer shell baseplate closing its lower or bottom end, a plurality of gas and oil mixture inlets positioned at the upper end of the tubular outer shell, and an upper mounting flange around the open upper end of the outer shell. A tubular vertically extending inner shell having an upper end is positioned within the outer shell.

The inner shell has an upper end and a lower end. The upper end of the inner shell is configured to create an upper filter placement passage. The lower end of the inner shell has a baseplate with a gas and oil filter opening and a filter seat positioned above the baseplate of the inner shell upon one or more vertically extending support posts. The filter seat has a central flow opening for introducing a gas and oil flow.

A vertically extending, centrally positioned tie rod bolt extends upward from the baseplate of the outer shell through the central flow opening of the filter seat of the inner shell. At least one tubular coalescing filter having appropriate filter media is placed upon the filter seat around the tie rod bolt. A filter cover plate is removably positionable over the tubular coalescing filter which is removably held in place by the tie rod bolt and attachment nut between the filter cover plate and the filter seat to secure the coalescing filter in place. The coalescing filter may be comprised of any suitable coalescing filter material or membrane such as those comprised of borosilicate glass microfiber and/or rayon/phenolic layers.

The filter assembly is positioned within the separator tank to redirect the outside-to-inside flow path of the gas/oil fluid mixture created by the separator tank baffle wall to an inside-to-outside the filter flow path. When the filter assembly is so positioned, the flow of the gas and oil mixture will be directed along the outer shell into the plurality of gas and oil mixture inlets at the upper end of the tubular outer shell. The flow of the gas and oil mixture will then be directed down the inner shell and through the central flow opening of the filter seat of the inner shell into the bottom of the coalescing filter. One or more oil scavenger lines may be provided with the filter assembly to deliver extraneous coalesced oil back to the air compressor.

While it is thought that the filter assembly of the present invention may be utilized as a replacement for a conventional coalescing filter system in a gas/oil separator tank having air and oil inlet, an upper air outlet, a lower oil outlet, and an internal baffle, it may also be incorporated into such a gas/oil separator tank upon its initial manufacture.

To use the filter assembly of the present invention, the separator cover plate above the top of separator tank of a gas compressor is removed. The standard filter assembly within the separator tank is disassembled and removed and the replacement coalescing filter assembly is then inserted within the gas/oil separator tank so that the upper mounting flange of the replacement filter assembly is positioned around the top opening of the separator tank. The separator cover plate is then reattached to the separator tank. Gaskets or seals may be placed between the upper mounting flange of the replacement filter assembly and the separator cover plate as required to maintain a gastight seal.

When configured and utilized as described herein, the filter assembly of the present invention will reduce or eliminate filtering inefficiencies due to stage separation of the oil and air mixture, inundation of the coalescing filter with oil, oil eruption due to direct contact with the oil and filter, collapse of the filter media, or the proximity of the separated oil to the coalescing filter. These and other advantages will be apparent from the description provided herein.

### BRIEF DESCRIPTION OF DRAWINGS

FIG. 1 is a schematic cross-section view of a gas/oil separator tank provided with a prior art filter assembly.

FIG. 2 is a schematic cross-section view of the gas/oil filter assembly of the present invention.

FIG. 3 is a schematic cross-section view of the gas/oil filter assembly of the present invention positioned in a separator tank such as that shown in FIG. 1.

FIG. 4 is an illustration of the flow path of a gas/oil fluid mixture within a separator tank having the gas/oil filter assembly as shown in FIG. 3.

FIG. 5 is an embodiment of the gas/oil filter assembly of FIG. 1 provided with foam barriers and vortex preventors.

FIG. 6 is another embodiment of the gas/oil filter assembly of the present invention.

These drawings may omit features that are established in the art and do not bear upon points of novelty in the interest of descriptive clarity. Such omitted features may include bearings, threaded junctures, weld lines, sealing elements, O-rings, pins, and brazed junctures.

### DETAILED DESCRIPTION OF THE INVENTION

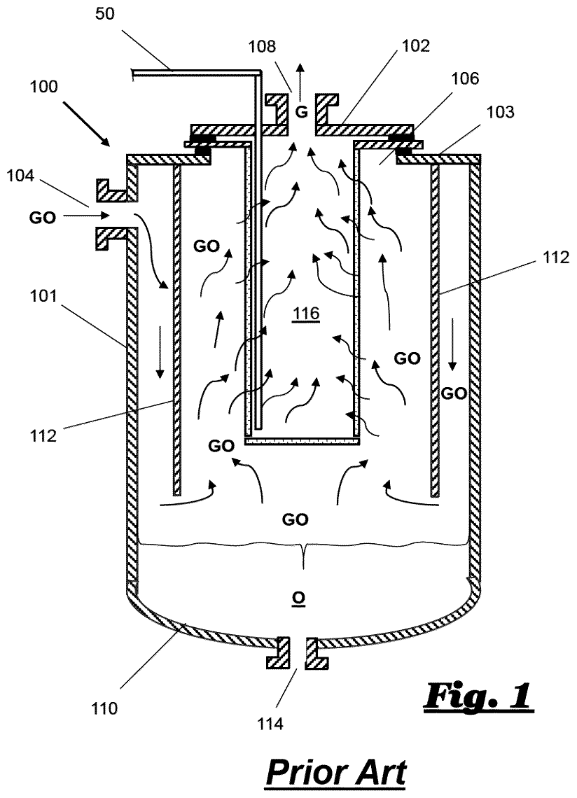

Referring to FIG. 1, there is shown a typical separator tank (100) of a gas/oil separator having a coalescing outside-to-inside filter assembly (116). The separator tank (100) shown in FIG. 1 is comprised of tank outer walls (101), a top opening (106) into the separator tank (100), a separator tank top flange (103) around the top opening (106), a removable separator cover plate (102) positioned upon separator tank top flange (103), a gas and oil inlet (104) in the outer wall (101), a gas outlet (108) through the separator cover plate (102), and a separator tank bottom (110) having an oil drain opening (114). Positioned within the separation tank (100) is an outside-to-inside filter assembly (116) and a baffle wall (112) located between the air and oil inlet (104) and the outside-to-inside filter (116). A scavenger line (50) for collection and delivery of extraneous coalesced oil (O) back to the gas compressor.

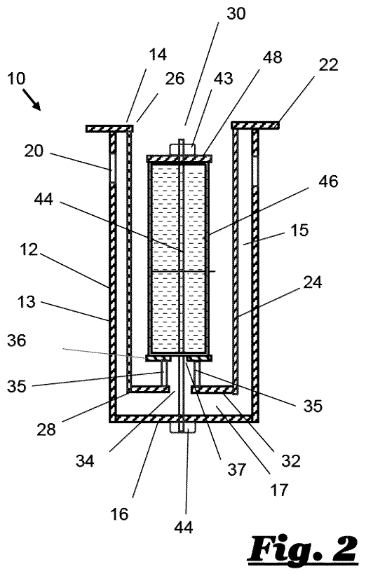

Referring now to FIG. 2, there is shown a gas/oil separator filter assembly (10) of the present invention to be utilized as a replacement for the outside-to-inside filter assembly (116) shown in FIG. 1. The gas/oil filter assembly (10) of the present invention is comprised of a vertically extending tubular outer shell (12) and a vertically extending tubular inner shell (24). Both the inner shell (24) and the outer shell (12) are suspended from an upper mounting flange (22). The upper mounting flange (22) is configured to be fitted over a separator tank top flange, such as the separator tank top flange (103) shown in FIG. 1.

The outer shell (12) of the gas/oil filter assembly (10) has an outer wall (13), a top end (14), an outer shell baseplate (16) closing its lower end (18). The inner shell (24) of the gas/oil filter assembly (10) has an upper end (26) configured to create an upper filter placement passage (30) and a lower end (28) having a baseplate (32) with a gas and oil fluid mixture opening (34). The inner shell (24) is positioned within the outer shell (12) to create an annular space (15) between the outer shell (12) and the inner shell (24) and a flow space (17) between the baseplate (16) of the outer shell (12) and the baseplate (32) of the inner shell (24). A plurality of gas and oil mixture inlets (20) extend through the outer wall (13) at the upper end of the tubular outer shell (12) into the annular space (15) between the outer shell (12) and the inner shell (24).

One or more vertically extending inner shell support posts (35) positioned around the gas and oil fluid mixture opening (34) of the baseplate (32) of the inner shell (24) support a filter seat (36) having a gas and oil fluid mixture opening (37). The support posts (35) are positioned on the base plate (32) to allow a gas/oil fluid mixture to flow from the annular space (15) into the flow space (17) and through the gas and oil fluid mixture opening (34) of the baseplate (32) into the gas and oil fluid mixture opening (37) of the filter seat (36).

At least one tubular coalescing filter (46) comprised on an appropriate coalescing filter media is placed upon the filter seat (36) around a tie rod bolt (44) that extends vertically upward from the baseplate (16) of the outer shell (12) through the gas and oil fluid mixture opening (34) of the inner shell (24) and the gas and oil fluid mixture opening (37) of the filter seat (36). A filter cover plate (48) is removably positionable over the tubular coalescing filter (46) to removably hold the coalescing filter (46) in place between the filter cover plate (48) and the filter seat (36) by the tie rod bolt (44) and an attachment nut (43). The coalescing filter (46) may be comprised of any suitable coalescing filter media or membrane such as those comprised of borosilicate glass microfiber and/or rayon/phenolic layers.

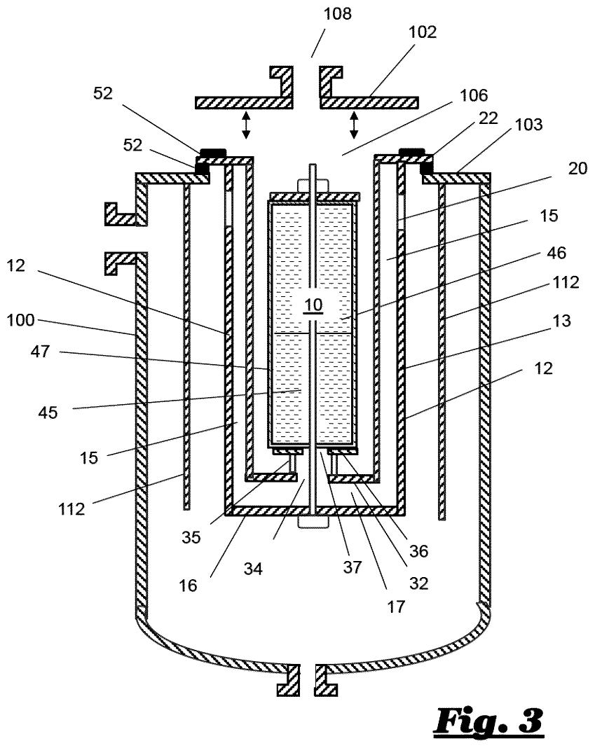

FIG. 3 shows the gas/oil filter assembly (10) of the present invention mounted within a separator tank (100) of the type shown in FIG. 1. The gas/oil filter assembly (10) is mounted within the separator tank (100) by detaching and removing the separator cover plate (102). Then the outside-to-inside filter assembly (116) of the separator tank (100) is removed through tank opening (106) and replaced with the gas/oil filter assembly (10) by mounting flange (22) of the gas/oil filter assembly (10) upon the tank flange (103) of the separator tank (100). The separator cover plate (102) is then reattached to the tank flange (103) of the separator tank (100). Gaskets or seals (52) may be used as required to maintain a gastight seal around the gas/oil filter assembly (10), the tank flange (103), and the tank cover plate (102).

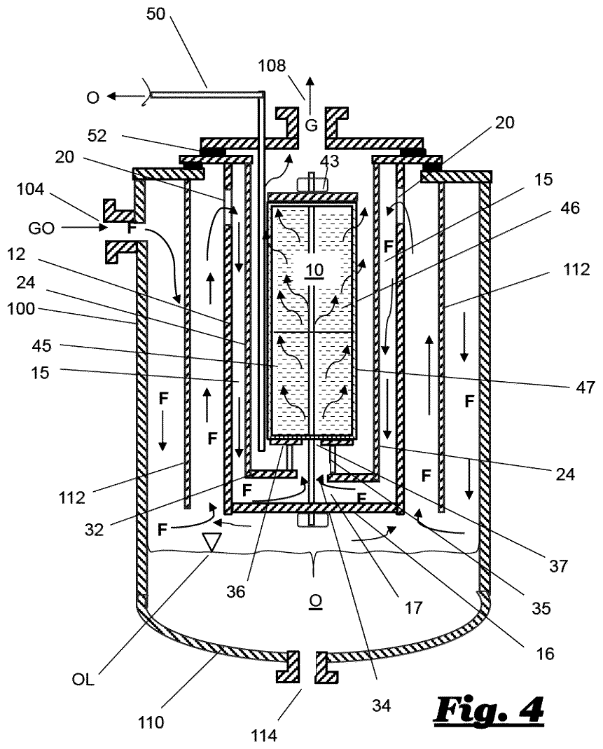

FIG. 4 is an illustration of the flow path (F) of a gas/oil fluid mixture (GO) within a separator tank (100) with the gas/oil filter assembly (10) properly positioned within the baffle wall (112) separator tank (100) as shown in FIG. 3. When the gas/oil filter assembly (10) so positioned, the flow (F) of the gas/oil fluid mixture (GO) from the air and oil inlet (104) of the separator (100) will be directed by the baffle wall (112) around the baffle wall (112) and upward into the gas and oil mixture inlets (20) at the upper end of the tubular outer shell (12) into the annular space (15). The gas/oil fluid mixture (GO) is then circulated downward in the annular space (15) between the outer shell (12) and the inner shell (24), around the inner shell base (32), into the central flow opening (34) in the filter seat (38) of the inner shell (24), and then through the inside (45) of the coalescing filter (46) to exit the outside (47) of the coalescing filter (46).

The gas/oil filter assembly (10) of the present invention coalesces the oil molecules in the gas/oil mixture (GO) so that the oil will fall to the bottom (110) of the separation tank (100) where it is collected and reused or recirculated through oil drain opening (114). The compressed air (G) produced from the circulating gas/oil mixture (GO) is then cooled, processed, and delivered to a supported system through air outlet (108) where it can be utilized. An oil scavenger line (50) may be provided with the filter assembly to deliver extraneous coalesced oil (O) back to the gas compressor.

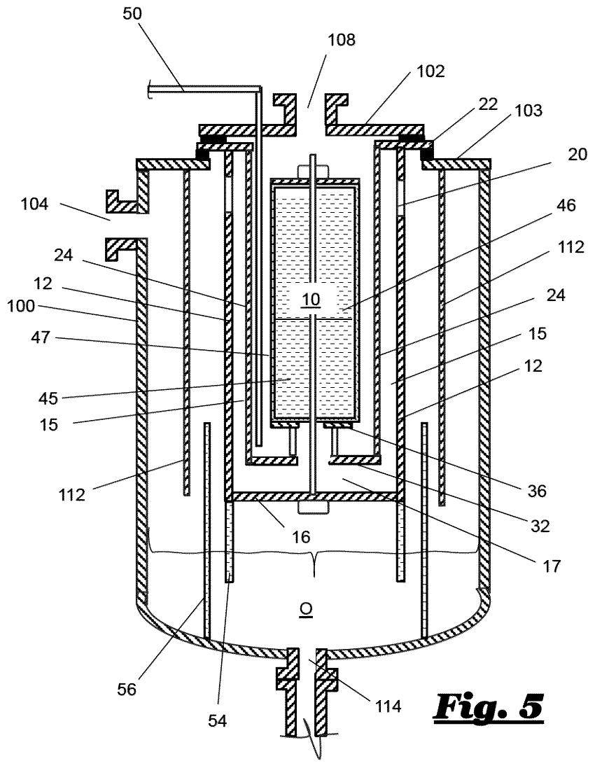

As shown in FIG. 5, the gas/oil filter assembly (10) of the present invention may include a first perforated barrier, shown as perforated cylinder (54), that extends around the circumference of the outer shell (12) below the outer shell baseplate (16), a second perforated barrier (56), shown as drop-in perforated cylinder (56), positioned between the baffle wall (112) and the outer shell (12), or both. The perforated cylinder (54) and drop-in perforated cylinder (56) would serve as breakers for foam in the gas and oil mixture (GO) which may form above the bottom (110) of the separation tank (100). The perforated cylinder (56) may also serve as a bearer that will reduce or eliminate the creation of a vortex in the gas and oil mixture (GO) during operation of the gas/oil separator.

It is thought that the perforated cylinder (54) will extend at least six inches below the outer shell base plate (16) depending upon the size of the separation tank (100). Preferably the perforated cylinder (56) will be supported by the bottom (110) of the separation tank (100). However, the perforated cylinder (56) may be attached to or supported by the baffle wall (112) or the outer shell (12).

The principal components of the gas/oil filter assembly (10) including the outer shell (12), the inner shell (24), baffle wall (112), perforated cylinder (54) and perforated cylinder (56) may be formed from any suitable material including steel, stainless steel, aluminum, or suitable polymer materials. One or more gas/oil filter assemblies (10) or (10A) may be utilized depending upon the size and configuration of the separator tank (100).

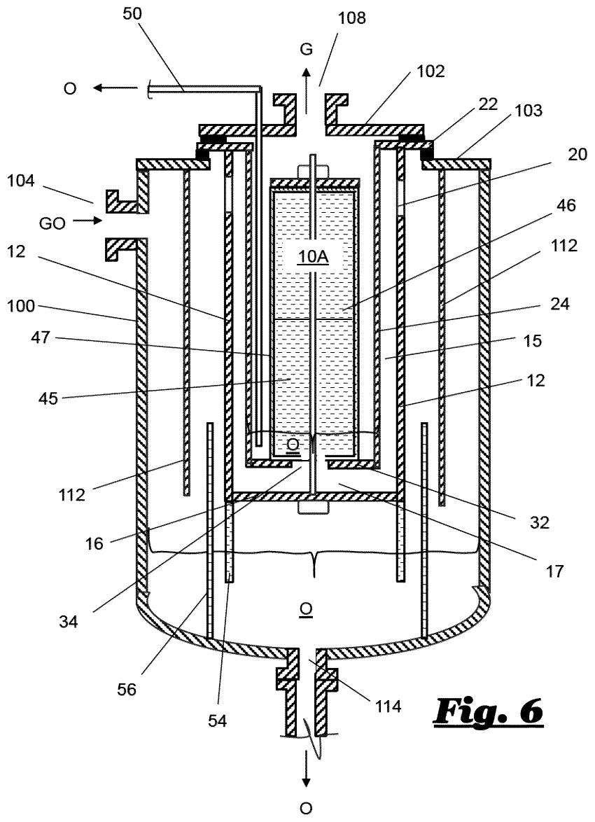

FIG. 6 shows another embodiment (10A) of the gas/oil filter assembly of the present invention. In this embodiment the filter support seat (32) and support post (35) have been eliminated allowing the coalescing filter (46) rests directly upon the baseplate (36) of the inner shell (24) of the gas/oil filter assembly. In the embodiment (10A) of the gas/oil filter assembly, oil (O) will pool at the lower end of the coalescing filter (46) as shown. A scavenger line (50) is essential in this configuration as the scavenger line (50) will allow pooling oil to be readily removed and recirculated. Perforated cylinder (54) and perforated cylinder (56) are optional features which may be utilized.

When configured and utilized as described herein, the gas/oil filter assembly (10) of the present invention will reduce or eliminate filtering inefficiencies due to stage separation of the oil and air mixture, inundation of the coalescing filter with oil, oil eruption due to direct contact with the oil and filter(collapse of the filter media, or the proximity of the separated oil to the coalescing filter. These and other advantages will be apparent from the description provided herein.

It is thought that the embodiments of the gas/oil filter assembly (10) presented herein, and its attendant advantages will be understood from the foregoing description. It will be apparent that various changes may be made in the form, construction, and arrangement of the parts of the embodiments of the gas/oil filter assembly (10) without departing from the spirit and scope of the invention or sacrificing its material advantages. The form and construction described and illustrated herein are merely example embodiments of the invention.

I claim:

1. A gas and oil separator filter assembly comprising:
a. a vertically extending tubular outer shell having an upper end, an outer shell wall having an outer shell gas and a lower end having an outer shell baseplate;
b. a tubular vertically extending inner shell having an upper end configured to create an upper filter placement passage and a lower end having an inner shell baseplate having a gas and oil fluid mixture opening, said inner shell positioned within said outer shell above said outer shell baseplate, thereby creating an annular space between said inner shell and said outer shell and a flow space between said outer shell baseplate and said inner shell baseplate;
c. a plurality of gas and oil mixture inlets through said outer shell wall into said annular space between said inner shell and said outer shell; and
d. a coalescing filter having an inside and an outside, said coalescing filter positioned within said inner shell above said gas and oil fluid mixture opening of said inner shell baseplate.

2. The gas and oil separator filter assembly recited in claim 1 wherein said tubular outer shell and said tubular inner shell extend vertically below a support flange.

3. The gas and oil separator filter assembly recited in claim 2, further comprising a filter seat having a gas and oil fluid mixture opening fluid positioned above said inner shell baseplate, said filter seat supporting said coalescing filter.

4. The gas and oil separator filter assembly recited in claim 3, further comprising a filter seat support.

5. The gas and oil separator filter assembly recited in claim 4, further comprising a first perforated cylinder positioned immediately beneath and attached to said outer shell baseplate.

6. The gas and oil separator filter assembly recited in claim 5, further comprising a second perforated cylinder positioned around said outer shell and said first perforated cylinder.

7. The gas and oil separator filter assembly recited in claim 6, wherein said filter seat support is comprised of a plurality of support posts.

8. The gas and oil separator filter assembly recited in claim 7, further comprising an oil scavenger line positioned in said annular space between said inner shell and said outer shell.

9. In a gas and oil separator having a separator tank having an upper end and a lower end, a separator tank gas and oil inlet between said upper end and said lower end of said separator tank whereby a flow of a gas and oil mixture is introduced into said separator tank, a separated oil outlet, and a separated gas outlet, and an interior baffle wall, said oil and gas separator further comprising:
a. at least one gas and oil separator filter assembly positioned within said separator tank, said gas and oil separator filter assembly comprising:
i. a support flange;
ii. a tubular outer shell extending vertically below said support flange, said outer shell having an upper end, a lower end, an outer shell outer wall, and an outer shell baseplate at said lower end of said outer shell;
iii. a tubular inner shell extending vertically below said support flange, said inner shell having an upper end and a lower end having a lower shell baseplate having a central opening, said inner shell positioned within said vertically extending outer shell above said outer shell baseplate thereby creating an annular space between said outer shell and said inner shell and a flow space between said outer shell baseplate and said inner shell baseplate;
iv. a gas and oil mixture inlet in said outer shell wall at said upper end of said outer shell into said annular space between said outer shell and said inner shell;
v. a tubular vertically extending coalescing filter positioned within said inner shell above said central opening of said lower shell baseplate, said tubular coalescing filter having an inside and an outside; and
b. wherein said air and oil separator filter assembly and said interior baffle wall are configured to provide a flow of a gas and oil mixture from said separator tank air and oil inlet around said baffle, into said gas and oil mixture inlet of said gas and oil filter assembly into said annular space between said outer shell and said inner shell outer wall of said gas and oil filter assembly, through gas and oil fluid mixture opening of said inner shell baseplate of said gas and oil filter assembly, and through said flow space between said outer shell baseplate and said inner shell baseplate of said gas and oil filter assembly, and through said coalescing filter of said gas and oil filter assembly from said inside of said coalescing filter to said outside of said coalescing filter.

10. In the gas and oil separator recited in claim 9, said oil and gas separator filter assembly further comprising a first perforated cylinder positioned immediately beneath and attached to said outer shell baseplate.

11. In the gas and oil separator recited in claim 10, said gas and oil separator filter assembly further comprising a second perforated cylinder positioned around said outer shell and said first perforated cylinder.

12. In the gas and oil separator recited in claim 9, said gas and oil filter assembly further comprising a filter seat having a central opening, said filter seat supported on a plurality of support posts extending vertically above said inner shell baseplate.

13. The gas and oil separator filter assembly recited in claim 12, said gas and oil filter assembly further comprising an oil scavenger line positioned in said annular space between said inner shell and said outer shell.

14. A method for providing a coalescing filter assembly having an inside-to-outside filter flow path for a gas and oil separator comprising the steps of:
a. providing a separator tank having a gas and oil inlet whereby a flow of a gas and oil mixture is introduced into said separator tank, said separator tank having an open upper end having a cover plate attachment flange, and a closed lower end, a gas and oil inlet between said upper end and said lower end of said separator tank whereby said flow of a gas and oil mixture is introduced into said separator tank, a separated oil outlet, a removable cover plate over said cover plate attachment flange, an interior baffle, and a separated air outlet;
b. providing a gas and oil coalescing filter assembly comprising;
i. a support flange;
ii. a tubular outer shell extending vertically below said support flange, said outer shell having an upper end, a lower end, an outer shell outer wall, and an outer shell baseplate at said lower end of said outer shell;
iii. a tubular inner shell extending vertically below said support flange, said inner shell having an upper end and a lower end having a lower shell baseplate having a central opening, said inner shell positioned within said vertically extending outer shell above said outer shell baseplate thereby creating an annular space between said outer shell and said inner shell and a flow space between said outer shell baseplate and said inner shell baseplate;
iv. a gas and oil mixture inlet in said outer shell wall at said upper end of said outer shell into said annular space between said outer shell and said inner shell;
v. a tubular vertically extending coalescing filter positioned within said inner shell above said central opening of said lower shell baseplate, said tubular coalescing filter having an inside and an outside; and
vi. wherein said air and oil separator assembly and said interior baffle wall are configured to provide a flow of a gas and oil mixture from said separator tank air and oil inlet around said baffle, into said gas and oil mixture inlet into said annular space between said outer shell and said inner shell outer wall, through gas and oil fluid mixture opening of said inner shell baseplate and through said flow space between said outer shell baseplate and said inner shell baseplate and through said inside of said coalescing filter to said outside of said coalescing filter;
c. removing said cover plate from said attachment flange of separator tank;
d. inserting said gas and oil coalescing filter assembly into said separator tank with said support flange of said gas and oil coalescing filter assembly upon said attachment flange of said separator tank; and
e. attaching said cover plate to said separator tank over said support flange of said gas and oil coalescing filter assembly.

15. The method for providing a coalescing filter assembly having an inside-to-outside filter flow path for a gas and oil separator as recited in claim 14, further comprising the additional steps of:
a. delivering said flow of a gas and oil mixture to said separator tank through said gas and oil mixture inlet; and
b. directing said flow of a gas and oil mixture around said baffle wall and through gas and oil mixture inlet into said annular space between said outer shell and said inner shell outer wall, through gas and oil fluid mixture opening of said inner shell baseplate and through said flow space between said outer shell baseplate and said inner shell baseplate and through said inside of said coalescing filter to said outside of said coalescing filter.

16. The method for providing a coalescing filter assembly having an inside-to-outside filter flow path for a gas and oil separator as recited in claim 15, further comprising the additional steps of providing seals between flange of said separator tank and said air and oil separator assembly.

17. The method for providing a coalescing filter assembly having an inside-to-outside filter flow path for a gas and oil separator as recited in claim 16, further comprising the additional steps of:
a. collecting oil separated from said gas and oil mixture; and
b. collecting gas separated from said gas and oil mixture.

18. The method for providing a coalescing filter assembly having an inside-to-outside filter flow path for a gas and oil separator as recited in claim 17, further comprising the additional steps of:
a. providing an oil scavenger line whereby extraneous coalesced oil is collected; and
b. collecting said extraneous coalesced oil through said oil scavenger line.

19. The method for providing a coalescing filter assembly having an inside-to-outside filter flow path for a gas and oil separator as recited in claim 18 further comprising the additional step of providing a first perforated cylinder positioned between said baffle wall and said outer shell.

20. The method for providing a coalescing filter assembly having an inside-to-outside filter flow path for a gas and oil separator as recited in claim 19, further comprising the additional step of providing a second perforated cylinder attached to said baseplate of said outer shell, said second perforated cylinder extending below and around said baseplate of said outer shell.
